(19) United States
(12) Patent Application Publication
(10) Pub. No.: US 2026/0023805 A1
(43) Pub. Date: Jan. 22, 2026

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: YUKI KATSUDA, Kanagawa (JP)

(21) Appl. No.: 19/265,791

(22) Filed: Jul. 10, 2025

(30) Foreign Application Priority Data
Jul. 22, 2024 (JP) 2024-116935

(51) Int. Cl. G06F 16/958; G06F 16/955; H04N 1/00

(52) U.S. Cl. CPC G06F 16/958; G06F 16/9566; H04N 1/00464

(57) ABSTRACT

An information processing apparatus discontinues, when a first operation including a single operation on a link or a browser-back operation is performed on a Web page, and in a case where a URL to be loaded based on the first operation is same as a URL of a Web page displayed last time, and a display period of the Web page is less than a threshold, loading processing of the URL to be loaded based on the first operation, and executes, when the first operation is performed on the Web page, and in a case where the URL to be loaded based on the first operation is not same as the URL of the Web page d, or the display period of the Web page is not less than the threshold, the loading processing of the URL to be loaded based on the first operation.

### BACKGROUND

### Field of the Technology

The present disclosure relates to an information processing apparatus, a control method of the information processing apparatus, and a storage medium.

### Description of the Related Art

Information processing apparatuses, such as a personal computer (PC) and a smartphone, acquire display information on a Web application (hereinafter, also called “web app”) by connecting to a web server on a network, so that the information processing apparatuses are able to display the Web app via a Web browser. Generally, the Web browser has a function for displaying a Web page, a function for updating a currently-displayed Web page, and a function for returning to a Web page immediately before the currently-displayed Web page.

The user can display a target Web app by selecting the content (hereinafter, called “Web content”) displayed on a Web page or a user interface (UI) for executing the above-described functions of the Web browser.

Meanwhile, image forming apparatuses including multi function peripherals (MFP), having a copying function and a transmitting function, may also have a Web browser for displaying a Web app. Some of the image forming apparatuses include an operation unit, such as a touch panel, so that the user can use a Web browser by an operation similar to an operation performed on other information processing apparatuses.

When the user uses a Web browser, the user may erroneously press the same Web content because of a specific reason to cause an unintended Web page to be displayed many times. For example, when the user performs a search, the user may unintentionally touch a banner advertisement or a floating advertisement, or may touch a regularly-used Web content by habit.

In a case where the user displays a Web page immediately before the currently-displayed Web page by using a function for returning to a Web page immediately before the currently-displayed Web page (hereinafter, called “browser-back function”) or by selecting Web content, Web content other than target Web content is also displayed on the Web page, so that the user may perform the same erroneous operation repeatedly.

Japanese Patent Laid-Open No. 2014-182289 describes a method for determining an interest level of the user based on a period of time the user has displayed a Web page before returning to a specific Web page, to prevent a user from selecting the unintended Web content by hiding the Web content of which display period by the user has been short.

A method for hiding a Web content arrangement may change other Web content in the Web page, which may degrade readability and operability of the Web page. A method for hiding a Web content to prevent a user from erroneously pressing the unintended Web content many times has an issue of degradation of readability and operability of a Web page.

### SUMMARY

The present disclosure is directed to a technique for discontinuing loading processing of a Uniform Resource Locator (URL) to be loaded based on an operation performed on a Web page, in a case where the operation satisfies a predetermined condition.

According to an aspect of the present disclosure, an information processing apparatus includes at least one memory and at least one processor which function as a discontinuation unit configured to discontinue, when a first operation including a single operation on a link or a browser-back operation is performed on a Web page, and in a case where a Uniform Resource Locator (URL) to be loaded based on the first operation is same as a URL of a Web page displayed last time, and a display period of the Web page displayed last time is less than a threshold, loading processing of the URL to be loaded based on the first operation, and a first execution unit configured to execute, when the first operation including the single operation on the link or the browser-back operation is performed on the Web page, and in a case where the URL to be loaded based on the first operation is not same as the URL of the Web page displayed last time, or the display period of the Web page displayed last time is not less than the threshold, the loading processing of the URL to be loaded based on the first operation.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of an information processing system.

FIG. 2 is a block diagram illustrating a hardware configuration of an image forming apparatus.

FIG. 3 is a block diagram illustrating a hardware configuration of a Web server.

FIG. 4 is a diagram illustrating a functional configuration of the image forming apparatus.

FIG. 5 is a diagram illustrating an example of HyperText Markup Language (HTML) descriptions of a link.

FIG. 6 is a diagram illustrating an example of a transition limitation list.

FIG. 7 is a flowchart illustrating processing for determining execution of loading processing after a Web browser acquires coordinates information.

FIG. 8 is a flowchart illustrating first loading processing.

FIGS. 9A and 9B are diagrams illustrating examples of a first operation.

FIG. 10 is a flowchart illustrating processing for determining execution of the loading processing after a Web browser acquires coordinates information.

FIG. 11 is a diagram illustrating an example of a non-unique Uniform Resource Locator (URL) of a load-destination.

FIG. 12 is a flowchart illustrating the first loading processing.

FIG. 13 is a diagram illustrating an example of a transition limitation list.

FIG. 14 is a flowchart illustrating the first loading processing.

FIG. 15 is a diagram illustrating a redisplay confirmation dialogue.

### DESCRIPTION OF THE EMBODIMENTS

The embodiments for implementing the present disclosure will be described below with reference to the drawings. The following embodiments are not intended to limit the disclosure as claimed in the claims, and not all combinations of features described in the embodiments are necessarily essential to the solutions provided by the present disclosure.

### First Embodiment

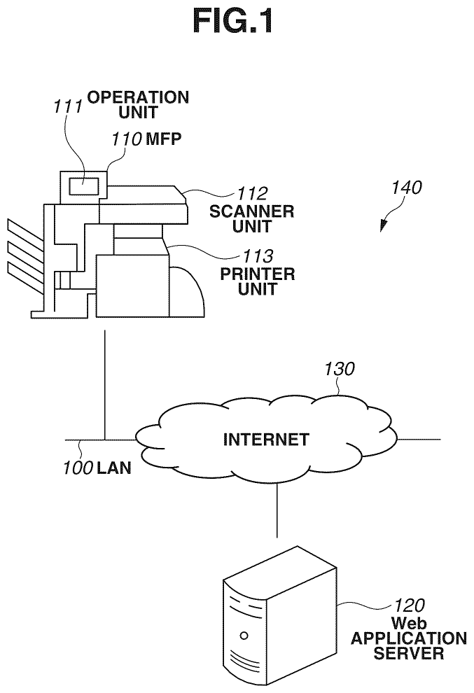

FIG. 1 is a diagram illustrating a configuration example of an information processing system 140 according to a first embodiment of the present disclosure. The information processing system 140 includes a multi function peripheral (MFP) 110 and a Web application server 120. The MFP 110 is an example of an image forming apparatus.

In this information processing system 140, the MFP 110 is connected to a local area network (LAN) 100, and the LAN 100 is connected to an internet 130. Further, the Web application server 120 is connected to the internet 130.

The MFP 110 includes an operation unit 111, a scanner unit 112, and a printer unit 113.

The MFP 110 according to the present embodiment also functions as a client terminal which allows the user to display and operate an operation screen of a Web application via a built-in Web browser. According to an instruction received via the Web application, the MFP 110 is able to transmit image data, which has been acquired by reading a document via the scanner unit 112, to the Web application, and is able to print an image acquired from the web application via the printer unit 113.

The Web application server 120 is a server which executes the web application. However, the above-described configuration of the information processing system 140 is merely examples, and a configuration, such as the number of devices, is not limited to the configuration described in the present embodiment.

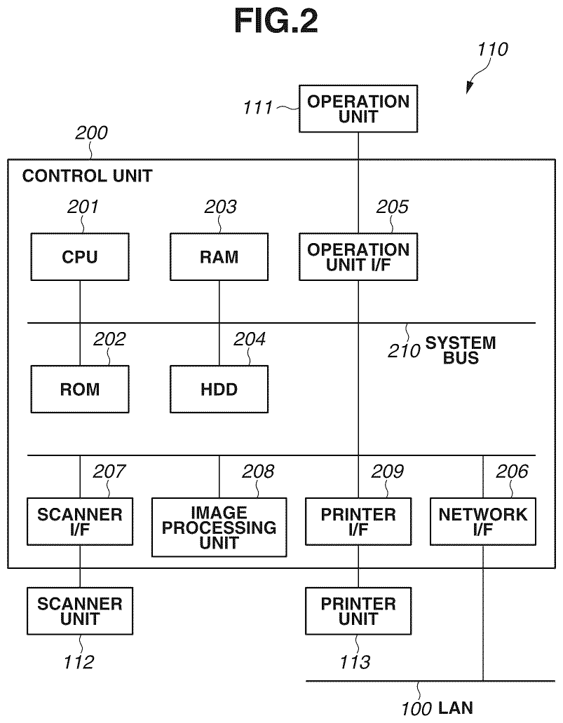

FIG. 2 is a block diagram illustrating a hardware configuration of the MFP 110 according to the present embodiment. The MFP 110 includes the operation unit 111, the scanner unit 112, the printer unit 113, and a control unit 200. The control unit 200 includes a central processing unit (CPU) 201, a read only memory (ROM) 202, a random access memory (RAM) 203, a hard disk drive (HDD) 204, an operation unit interface (I/F) 205, a network I/F 206, a scanner I/F 207, an image processing unit 208, a printer I/F 209, and a system bus 210.

The operation unit 111 includes a display unit having a touch panel function and various hard keys, displays information to the user according to data received from the control unit 200, and inputs information to the control unit 200 according to an operation performed by the user.

The scanner unit 112 reads an image of a document, generates image data of the image, and supplies the image data to the control unit 200.

The printer unit 113 prints an image on a sheet, based on the image data received from the control unit 200.

The control unit 200 is electrically connected to the operation unit 111, the scanner unit 112, and the printer unit 113, and is further connected to the LAN 100 via the network I/F 206. With this configuration, the control unit 200 is able to execute communication via the LAN 100 by using a communication protocol, such as Transmission Control Protocol/Internet Protocol (TCP/IP).

In the control unit 200, the CPU 201, the ROM 202, the RAM 203, the HDD 204, the operation unit I/F 205, the network I/F 206, the scanner I/F 207, the image processing unit 208, and the printer I/F 209 are connected to each other via the system bus 210.

The CPU 201 loads an operating system (OS) and a control program stored in the HDD 204 to the RAM 203 by executing a boot program stored in the ROM 202, and performs control over the MFP 110 based on the control program. The above-described control also includes execution of a program for implementing the processing illustrated in the flowcharts described below.

The ROM 202 stores a boot program of the MFP 110 and various data.

The RAM 203 provides a work memory for the CPU 201 to operate and also provides an image memory where image data is stored temporarily.

The HDD 204 stores the OS, various programs, and various image data.

The operation unit I/F 205 is an interface for connecting the operation unit 111 to the system bus 210.

The network I/F 206 is connected to the LAN 100 and the system bus 210, and inputs and outputs information via the network.

The scanner I/F 207 controls an interface between the scanner unit 112 and the control unit 200.

The image processing unit 208 executes image processing, such as rotation, color conversion, image compression/decompression processing on image data received from the scanner unit 112 and image data to be output to the printer unit 113.

The printer I/F 209 receives the image data processed by the image processing unit 208 and controls the printing operation that is executed by the printer unit 113, according to attribute data attached to the image data.

In the present embodiment, the MFP 110 capable of displaying a user interface (UI) using the operation unit 111 is described as an example. However, an information processing apparatus, such as a smartphone, can also be used instead of the MFP 110. The MFP 110 is an example of the information processing apparatus.

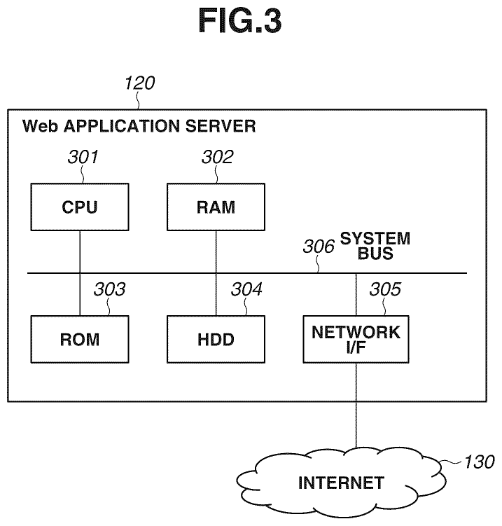

FIG. 3 is a block diagram illustrating an example of the hardware configuration of the Web application server 120 according to the present embodiment.

The Web application server 120 includes a CPU 301, a RAM 302, a ROM 303, an HDD 304, and a network I/F 305, which are connected to each other via a system bus 306 to communicate with each other.

The ROM 303 stores a boot program. The CPU 301 reads this boot program when the power is turned on, and loads an OS and a control program to be installed in the HDD 304 to the RAM 302. Then, the CPU 301 implements the functions of the Web application server 120 by executing the program loaded on the RAM 302.

The CPU 301 executes communication with the other apparatus which is present on the network and is connected to the Web application server 120, via the network I/F 305.

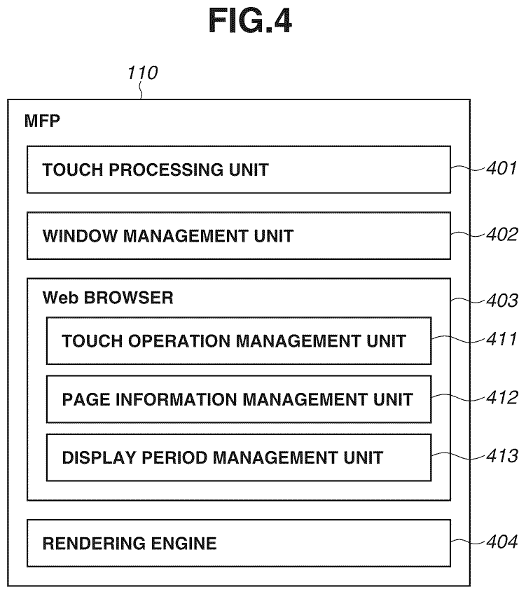

FIG. 4 is a diagram illustrating an example of a functional configuration of the MFP 110 according to the present embodiment. Software modules for implementing these functional configurations are stored in the HDD 204 of the MFP 110, loaded on the RAM 203, and executed by the CPU 201.

The MFP 110 includes a touch processing unit 401, a window management unit 402, a Web browser 403, and a rendering engine 404. The Web browser 403 includes a touch operation management unit 411, a page information management unit 412, and a display period management unit 413.

The touch processing unit 401 converts information about an analog position that has been pressed on the operation unit 111, into digital coordinates information.

The window management unit 402 determines a pressed software module, in accordance with layer information of a window displaying software modules, and transmits the coordinates information converted by the touch processing unit 401.

The Web browser 403 executes general functions, such as loading processing and a browser-back function, based on the coordinates information acquired from the window management unit 402.

In the loading processing, the Web browser 403 requests the Web application server 120 to transmit information, based on a Uniform Resource Locator (URL). Then, rendering information on a Web page is created by the rendering engine 404 according to the information received from the Web application server 120, and displayed on the operation unit 111.

In a browser-back operation, the Web browser 403 refers to a browsing history of Web pages and loads a URL of a Web page immediately before the currently-displayed Web page.

The Web browser 403 includes the touch operation management unit 411, the page information management unit 412, and the display period management unit 413, in addition to general functions.

After acquisition of coordinates information from the window management unit 402, the touch operation management unit 411 determines whether the user has performed a first operation based on the coordinates information, and determines whether to execute the first loading processing. The first operation is either a touch or a browser-back operation performed on the Web content (hereinafter, called “link”) having page information for uniquely identifying the Web page.

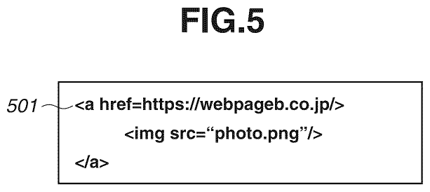

In the present embodiment, the page information describes a URL included in HyperText Markup Language (HTML) descriptions of the Web content. FIG. 5 is a diagram illustrating an example of HTML descriptions of a link. The URL is described in a hypertext reference (href) attribute 501 of an anchor element (<a> element), and the href attribute can be acquired by JavaScript (hereinafter, called “JS”). As a specific example, the href attribute of the Web content located at a position corresponding to coordinates [200, 300] can be acquired by executing document.elementFromPoint (200, 300). The first loading processing is executed by the first operation. The first loading processing is loading processing for discontinuing loading processing in a case where a display period of the Web page browsed last time is less than a threshold.

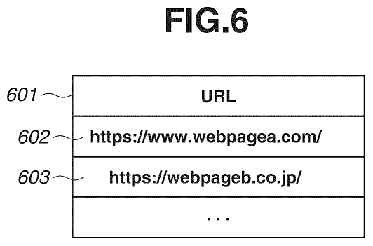

The page information management unit 412 determines whether acquired page information is included in a transition limitation list, and determine whether to discontinue the loading processing. FIG. 6 is a diagram illustrating an example of the transition limitation list according to the present embodiment. The transition limitation list includes a URL 601, and a URL of a Web page displayed for a period less than the threshold is stored. In a case where URLs 602 and 603 are stored in the transition limitation list, loading processing of Web pages for the URLs 602 and 603 is discontinued when the first loading processing is executed.

The display period management unit 413 measures a display period of the currently-displayed Web page, and based on the display period, the display period management unit 413 determines whether the Web page is displayed intentionally. In a measurement of a display period, the display period management unit 413 starts a measurement of the display period from when loading processing of the Web page is completed, and stops measurement of the display period immediately before next loading processing is executed. In determination using a display period, the display period management unit 413 determines whether to load a Web page displayed immediately before the currently-displayed Web page, and also determines whether a display period is less than a predetermined threshold.

In a case where both of the above determination conditions are satisfied, the display period management unit 413 adds the page information of the loading Web page to the transition limitation list.

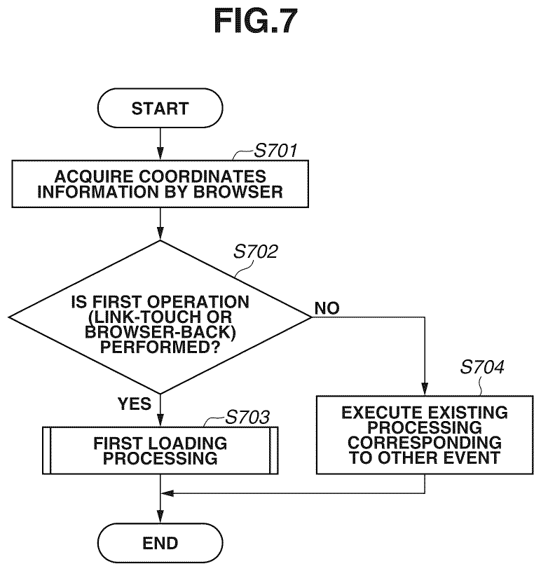

FIG. 7 is a flowchart illustrating processing that is performed to determine execution of loading processing after the Web browser 403 according to the present embodiment acquires coordinates information. The processing illustrated in the flowchart in FIG. 7 is implemented by the CPU 201 loading a program stored in the ROM 202 or the HDD 204 to the RAM 203 and executing the program. A control method of the MFP 110 is described below.

In step S701, the touch operation management unit 411 acquires coordinates information on a pressed position performed in the operation unit 111 from the window management unit 402.

In step S702, based on the coordinates information acquired in step S701, the touch operation management unit 411 determines whether the operation performed on the operation unit 111 is the first operation. Herein, the first operation is either a touch performed on the Web content (i.e., link) having page information for uniquely identifying the Web page, or a browser-back operation. In a case where the performed operation is the first operation (YES in step S702), the processing proceeds to step S703. In a case where the performed operation is not the first operation (NO in step S702), the processing proceeds to step S704.

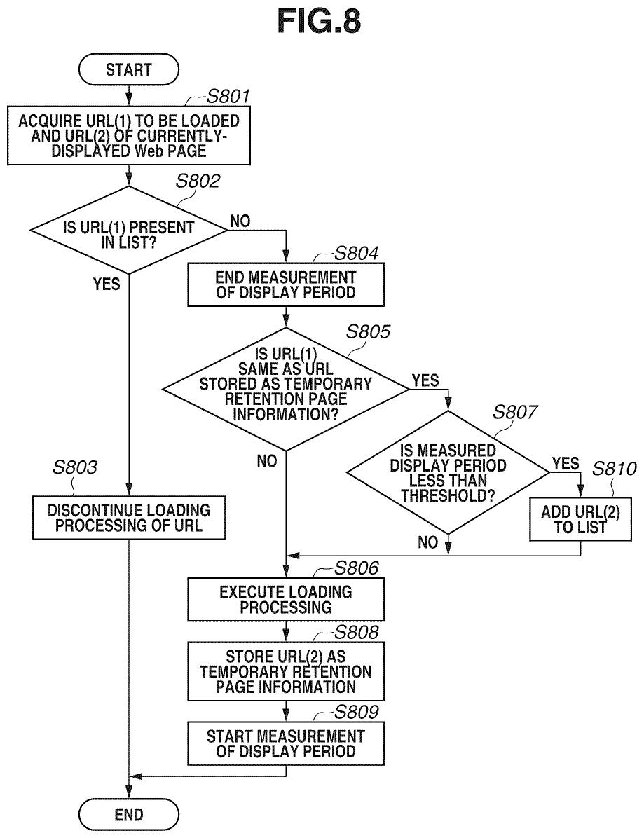

In step S703, the touch operation management unit 411 executes the first loading processing described below in FIG. 8.

In step S704, the touch operation management unit 411 executes existing processing for the operation other than the first operation. Existing processing is processing that is not corresponding to the first operation and depends on Web content and a Web browser function described in the HTML descriptions.

FIG. 8 is a flowchart illustrating the first loading processing executed in step S703 of FIG. 7. The processing illustrated in the flowchart in FIG. 8 is implemented by the CPU 201 loading a program stored in the ROM 202 or the HDD 204 to the RAM 203 and executing the program.

In step S801, the page information management unit 412 acquires a URL to be loaded by the above-described first operation and a URL of a currently-displayed Web page. The URL to be loaded is acquired from the href attribute 501 (FIG. 5) included in Web content and a browsing history of Web pages.

The URL of the currently-displayed Web page can be acquired by JS by executing location.href.

In step S802, the page information management unit 412 determines whether the URL to be loaded, acquired in step S801, is present in the transition limitation list in FIG. 6. In a case where the URL is present in the transition limitation list (YES in step S802), the processing proceeds to step S803. In a case where the URL is not present in the transition limitation list (NO in step S802), the processing proceeds to step S804.

In step S803, the page information management unit 412 discontinues the loading processing of the URL acquired in step S801.

In step S804, the display period management unit 413 ends measurement of the display period of the currently-displayed Web page.

In step S805, the display period management unit 413 determines whether the URL to be loaded is same as the URL of the Web page displayed immediately before the currently-displayed Web page. The URL of the Web page displayed immediately before the currently-displayed Web page is acquired from the URLs stored as temporary retention page information described below in step S808. In a case where the URL to be loaded is not present in the temporary retention page information, the display period management unit 413 determines that the URL to be loaded is different from the URL of the Web page displayed immediately before the currently-displayed Web page. In a case where the URL to be loaded is present in the temporary retention page information, the display period management unit 413 determines that the URL is same as the URL of the Web page displayed immediately before the currently-displayed Web page. In a case where the URL to be loaded is same as the URL of the Web page displayed immediately before the currently-displayed Web page (YES in step S805), the processing proceeds to step S807. In a case where the URL to be loaded is different from the URL of the Web page displayed immediately before the currently-displayed Web page (NO in step S805), the processing proceeds to step S806.

In step S807, the display period management unit 413 determines whether a display period of the currently-displayed Web page measured in step S804 is less than the predetermined threshold. In a case where the display period is less than the threshold (YES in step S807), the processing proceeds to step S810. In a case where the display period is not less than the threshold (NO in step S807), the processing proceeds to step S806.

In step S810, the display period management unit 413 adds the URL to be loaded to the transition limitation list in FIG. 6. Thereafter, the processing proceeds to step S806.

In step S806, based on the URL to be loaded, the display period management unit 413 executes loading processing by the Web browser 403, and executes control to display a Web page specified by the URL loaded by the loading processing.

After completion of the loading processing in step S806, in step S808, the display period management unit 413 stores the URL of the Web page displayed before the loading processing as temporary retention page information.

In step S809, the display period management unit 413 starts measurement of a display period of the Web page which has been displayed by the processing in step S806.

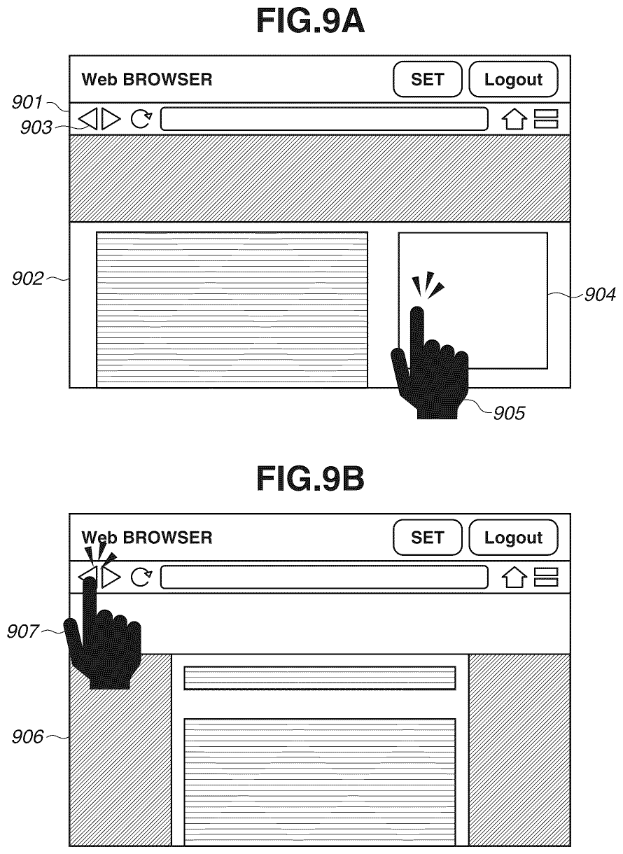

FIGS. 9A and 9B are diagrams illustrating examples of the first operation according to the present embodiment.

FIG. 9A is a diagram illustrating an example of the operation when the user erroneously selects a link. A display area of the Web browser 403 displayed on the operation unit 111 includes a Web browser function area 901 and a Web page rendering area 902.

In the Web browser function area 901, UIs for executing general functions of the Web browser 403 including a return button 903 for executing a browser-back operation are arranged.

In the Web page rendering area 902, a Web page A whose URL is the URL 602 in FIG. 6 is displayed. The Web page A includes a Web content 904 having the URL 603 of a Web page B as page information.

FIG. 9B is a diagram illustrating an example of the operation when the user executes a browser-back operation. The Web page B having the URL 603 in FIG. 6 as its URL is displayed in a Web page rendering area 906.

When the user performs an operation 905 for the first time and erroneously selects the Web content 904, the touch operation management unit 411 acquires coordinates [520, 450] in step S701.

In step S702, because the Web content 904 selected by the coordinate position via JS has the URL 603 in FIG. 6, the touch operation management unit 411 determines that the performed operation is the first operation, and executes the first loading processing in step S703.

In step S801 of the first loading processing, the page information management unit 412 acquires the URL 603 of the Web content 904 and the URL 602 of the Web page A, which is currently-displayed, via JS.

In step S802, the page information management unit 412 determines that the URL 603 is not present in the transition limitation list illustrated in FIG. 6, so that the processing proceeds to step S804.

In step S804, the display period management unit 413 ends measurement of a display period of the Web page A, which is currently-displayed.

In step S805, the display period management unit 413 determines whether the URL 603 is present in the temporary retention page information. In this case, the URL 603 is not present in the temporary retention page information. Thus, the processing proceeds to step S806.

In step S806, the display period management unit 413 executes control to display the Web page B by executing loading processing of the URL 603.

Thereafter, in step S808, the display period management unit 413 stores the URL 602 of the Web page A as the temporary retention page information.

In step S809, the display period management unit 413 starts measurement of a display period of the Web page B.

When the user performs an operation 907 to select the return button 903 in FIGS. 9A and 9B, in step S701, the touch operation management unit 411 acquires coordinates [40, 120].

In step S702, the coordinate position is located in an area where the return button 903 is displayed. Therefore, the touch operation management unit 411 determines that the performed operation is the first operation, and executes the first loading processing in step S703.

In step S801 of the first loading processing, the page information management unit 412 acquires the URL 602 from the browsing history of the Web pages and the URL 603 of the Web page B, which is currently-displayed.

In step S802, the page information management unit 412 determines that the URL 602 is not present in the transition limitation list, so that the processing proceeds to step S804.

In step S804, the display period management unit 413 ends measurement of a display period of the Web page B, which is currently-displayed. In this case, 0.8 seconds is acquired as a measurement value of the display period of the Web page B.

In step S805, the display period management unit 413 determines whether the URL 602 is present in the temporary retention page information. In this processing, the URL 602 has been stored as the temporary retention page information when the operation 905 has been performed for the first time. Therefore, the processing proceeds to step S807.

In step S807, the display period management unit 413 determines whether the display period of the Web page B which is currently-displayed is less than the predetermined threshold. In this case, because a measurement value of the display period of the Web page B is less than the threshold, the processing proceeds to step S810.

In step S810, the display period management unit 413 adds the URL 603 to the transition limitation list.

In step S806, the display period management unit 413 executes control to display the Web page A by executing loading processing of the URL 602.

Thereafter, in step S808, the display period management unit 413 stores the URL 603 of the Web page B as the temporary retention page information.

In step S809, the display period management unit 413 starts measurement of a display period of the Web page A.

When the operation 905 is performed for the second time, the processing same as the processing executed when the operation 905 has been performed for the first time is executed up to step S801. However, in step S802, the URL 603 is present in the transition limitation list. Thus, the processing proceeds to step S803, so that the loading processing is discontinued.

As described above, in a case where the first operation including a single operation on a link or a browser-back operation is performed on the Web page in step S702 of FIG. 7, the processing proceeds to step S703. Herein, for example, the single operation on the link is a single-touch on the link.

In step S802, in a case where the URL to be loaded based on the first operation is same as the URL of the Web page displayed last time, and a display period of the Web page displayed last time is less than the threshold, the processing proceeds to step S803.

In step S802, in a case where the URL to be loaded based on the first operation is different from the URL of the Web page displayed last time, or a display period of the Web page displayed last time is greater than or equal to the threshold, the processing proceeds to step S804.

In step S803, the page information management unit 412 functions as a discontinuation unit to discontinue the loading processing of the URL to be loaded based on the first operation.

In step S806, the display period management unit 413 functions as an execution unit to execute the loading processing of the URL to be loaded based on the first operation.

As described above, loading processing of the Web content 904 regarded as a cause of an erroneous selection is discontinued through the processing in FIGS. 7 and 8, whereby it is possible to prevent the user from making an erroneous selection without having an effect on display of the Web content 904. Accordingly, the Web content 904 does not have to be hidden in order to prevent the user from erroneously pressing the unintended Web content 904 many times. Therefore, it is possible to solve the issue of degradation of readability and operability of the Web page.

### Second Embodiment

Differences between a second embodiment and the first embodiment are described with respect to an issue occurring from implementation of the processing in FIG. 7 of the first embodiment.

The present embodiment is described with respect to a case where loading processing is discontinued in the first loading processing even though the operation is performed by the user with clear intention of displaying a Web page.

A multi-touch operation and a touch-and-hold operation can be given as the examples of the operation that is performed by the user with clear intention of displaying a Web page. When the user selects Web content having a link through a multi-touch operation or a touch-and-hold operation, the Web browser 403 may display a menu screen for allowing the user to perform operations, such as a copying operation and a saving operation, on the selected Web content. The menu screen includes an item for displaying a Web page, and a Web page is displayed by the user performing a continuous pressing operation. Thus, displaying a Web page through a multi-touch or a touch-and-hold operation is considered to be the operation intentionally performed by the user. However, there is an issue in which even the loading processing executed based on the continuous operation is similarly discontinued through the processing described in the first embodiment.

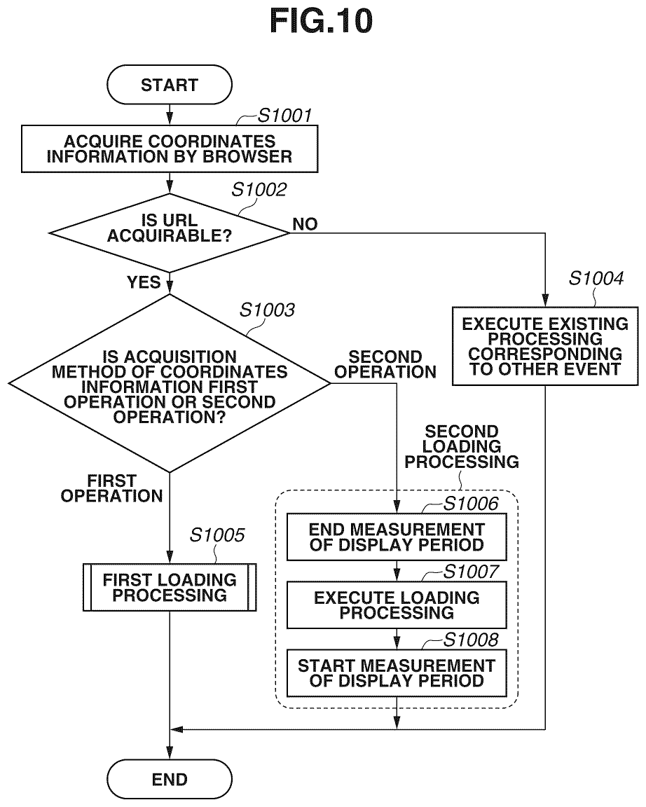

FIG. 10 is a flowchart illustrating processing for determining execution of loading processing after the Web browser 403 according to the present embodiment acquires coordinates information. The processing illustrated in the flowchart in FIG. 10 is implemented by the CPU 201 loading a program stored in the ROM 202 or the HDD 204 to the RAM 203 and executing the program.

The procedures of the processing executed in steps S1001, S1004, and S1005 corresponds to the procedures of the processing executed in steps S701, S704, and S703 in FIG. 7.

After the processing in step S1001, in step S1002, the touch operation management unit 411 determines whether the URL is acquirable based on the coordinates information acquired in step S1001.

In a case where the URL is acquirable (YES in step S1002), the processing proceeds to step S1003. In a case where the URL is not acquirable (NO in step S1002), the processing proceeds to step S1004.

In step S1003, the touch operation management unit 411 determines whether the acquisition method of the coordinates information acquired in step S1001 is the first operation or the second operation. The first operation is either a single-touch operation on a link or a browser-back operation. The second operation is either a multi-touch operation on a link or a touch-and-hold operation on a link. With respect to the multi-touch operation or the touch-and-hold operation, the acquisition method is not able to be determined from the coordinate position. Thus, the acquisition method is determined from the other coordinates information, such as the number of positions pressed simultaneously or a pressing period. In a case where the acquisition method of the coordinates information is the first operation (FIRST OPERATION in step S1003), the processing proceeds to step S1005, and the first loading processing is executed. In a case where the acquisition method of the coordinates information is the second operation (SECOND OPERATION in step S1003), the processing proceeds to step S1006, and second loading processing is executed.

In step S1003, in a case where the second operation including a multi operation or a touch-and-hold operation of a link is performed on the Web page, the processing proceeds to step S1006. Herein, for example, the multi operation of a link is a multi-touch operation on a link.

In step S1006, the display period management unit 413 ends measurement of a display period of the currently-displayed Web page.

In step S1007, the display period management unit 413 functions as an execution unit to execute loading processing of the URL to be loaded based on the second operation by the Web browser 403, and executes control to display a Web page specified by the loaded URL.

In step S1008, the display period management unit 413 starts measurement of a display period after initializing a value of the display period.

An example the operation when the operation 905 performed for the second time is a multi-touch is described with reference to FIG. 9A.

In step S1001, the touch operation management unit 411 acquires coordinates [520, 450] and coordinates [540, 450] from the window management unit 402.

In step S1002, the touch operation management unit 411 determines that the URL 602 is acquirable based on the coordinates information acquired in step S1001. In this case, the URL 602 is acquirable, and the processing proceeds to step S1003.

Because a plurality of sets of coordinates is acquired in step S1001, in step S1003, the touch operation management unit 411 determines that a multi-touch is performed as the second operation. Therefore, the processing proceeds to step S1006.

In step S1006, the display period management unit 413 ends measurement of a display period of the Web page A.

In step S1007, the display period management unit 413 executes loading processing of the Web page B, and executes control to display the Web page B.

In step S1008, the display period management unit 413 starts measurement of a display period of the Web page B.

As described above, the second operation is defined through the processing in FIG. 10, and loading processing is executed as the second loading processing different from the first loading processing. In this way, the loading processing is able to be prevented from being discontinued. Accordingly, an issue of degrading the user's operability can be solved because the loading processing executed based on the operation which is performed by the user with clear intention of displaying a Web page is prevented from being discontinued.

### Third Embodiment

Differences between a third embodiment and the first embodiment are described with respect to an issue occurring from implementation of the processing in FIG. 8 of the first embodiment.

The present embodiment is described with respect to a case where a loading destination has a non-unique URL. In this case, because of the non-unique URL, even if the user unintentionally selects the Web content, the loading processing is not discontinued, so that a Web page is displayed.

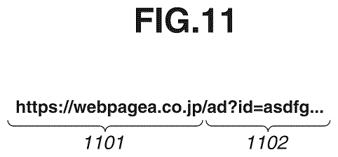

FIG. 11 illustrates a URL of an advertisement as an example of the loading destination having a non-unique URL. Some URLs of an advertisement are URLs which makes displayed content of the advertisement be changed every time a Web page having the advertisement as Web content is displayed, so that a different Web page is displayed after the Web content is selected. In this case, each URLs in advertisement Web contents has a description portion 1101 and a description portion (hereinafter, called “query parameter”) 1102, and the query parameter 1102 is uniquely applied to each of advertisement Web pages.

In the first embodiment, these URLs are individually stored in the transition limitation list in FIG. 6, and consequently, the URLs are not recognized as the same page information. Thus, even in a case where the Web content located at the same coordinate position is selected again, loading processing is not discontinued if the Web content has a URL having a different query parameter 1102.

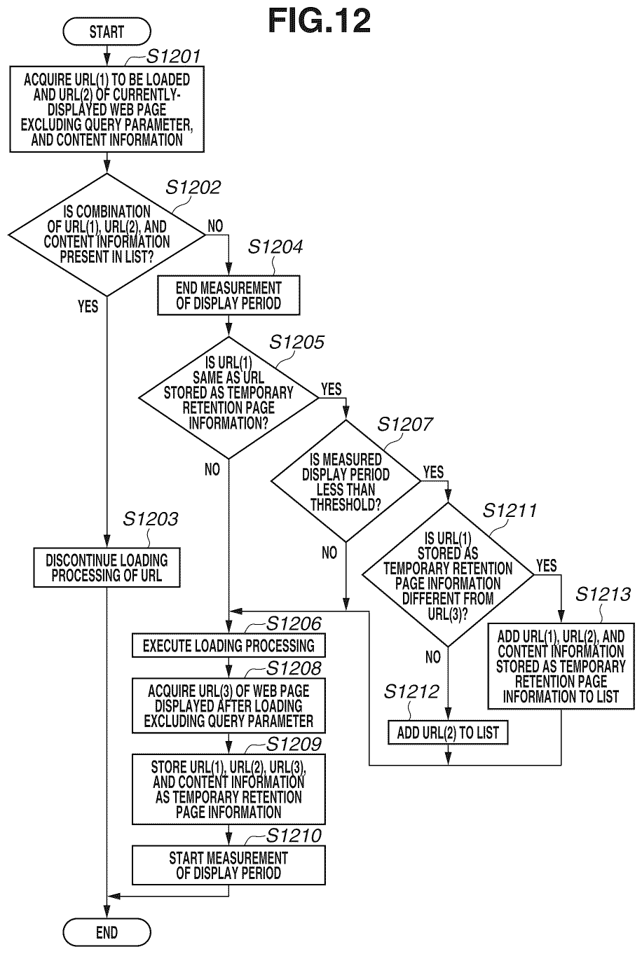

FIG. 12 is a flowchart illustrating the first loading processing according to the present embodiment. The processing illustrated in the flowchart in FIG. 12 is implemented by the CPU 201 loading a program stored in the ROM 202 or the HDD 204 to the RAM 203 and executing the program.

The content of the processing executed in steps S1203, S1204, S1206, S1207, S1210, and S1212 corresponds to the content of the processing executed in steps S803, S804, S806, S807, S809, and S810 in FIG. 8.

In step S1201, the page information management unit 412 acquires page information based on the coordinates information. In the present embodiment, the page information indicates a URL to be loaded, a URL of a currently-displayed Web page, and an HTML attribute of the Web content located at a position indicated by the coordinates information excluding the href attribute (hereinafter, called “content information”). In this processing, the URL to be loaded and the URL of the currently-displayed Web page are acquired as the URLs excluding query parameter 1102. The HTML attribute is able to be acquired by JS, and the HTML attribute of the Web content located at a position corresponding to the coordinates [200, 300] is able to be acquired by executing “document.elementFromPoint (200, 300).attributes”.

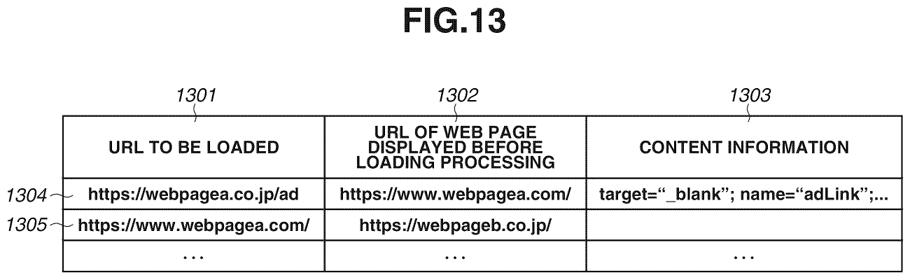

In step S1202, the page information management unit 412 determines whether a combination of the page information acquired in step S1201 is present in the transition limitation list in FIG. 13. FIG. 13 illustrates an example of the transition limitation list according to the present embodiment. The transition limitation list includes a URL 1301 to be loaded, a URL 1302 of a Web page displayed before loading processing, and content information 1303.

With respect to the loading processing based on the operation, such as a touch on a link, by which the content information is able to be acquired from coordinates information, presence or absence of a combination of page information is determined from page information 1304 including all pieces of the page information. With respect to the loading processing based on the operation, such as a browser-back, by which the content information is not able to be acquired from coordinates information, presence or absence of a combination of page information is determined from page information 1305 within the transition limitation list, to which the content information 1303 is not added.

In a case where a combination of page information is present in the transition limitation list in FIG. 13 (YES in step S1202), the processing proceeds to step S1203. In a case where a combination of page information is not present in the transition limitation list in FIG. 13 (NO in step S1202), the processing proceeds to step S1204.

After the processing in step S1204, in step S1205, the display period management unit 413 determines whether the URL to be loaded is same as the URL of the Web page displayed immediately before the currently-displayed Web page. The URL of the Web page displayed immediately before the currently-displayed Web page is acquired from the URL of the Web page displayed before loading processing, stored as the temporary retention page information described below in step S1209. In a case where the URL is not the URL of the Web page displayed immediately before the currently-displayed Web page (NO in step S1205), the processing proceeds to step S1206. In a case where the URL is the URL of the Web page displayed immediately before the currently-displayed Web page (YES in step S1205), the processing proceeds to step S1207.

In step S1207, in a case where a display period is less than a threshold (YES in step S1207), the processing proceeds to step S1211. In a case where a display period is not less than the threshold (NO in step S1207), the processing proceeds to step S1206.

In step S1211, the display period management unit 413 compares a character string of the URL based on the coordinates information before loading processing, which has been stored as the temporary retention page information, and a character string of the URL of the Web page displayed after the loading processing, which has been stored as the temporary retention page information. In a case where the character strings are not different from each other (NO in step S1211), the processing proceeds to step S1212. In a case where the character strings are different from each other (YES in step S1211), the processing proceeds to step S1213.

The processing in step S1212 is similar to the processing in step S810 of FIG. 8. Then, the processing proceeds to step S1206.

In step S1213, the display period management unit 413 adds the URL based on the coordinates information and the URL of the Web page displayed before loading processing, and the content information, which have been stored as the temporary retention page information, to the transition limitation list in FIG. 13. Then, the processing proceeds to step S1206.

After completion of the loading processing in step S1206, in step S1208, the display period management unit 413 acquires a URL of the Web page that is displayed after the loading processing. In this processing, the URL of the Web page displayed after the loading processing is acquired as a URL excluding the query parameter 1102.

In step S1209, the display period management unit 413 stores page information and the URL of the Web page that is displayed after the loading processing, as the temporary retention page information. In the present embodiment, the temporary retention page information includes a URL based on the coordinates information, a URL of the Web page displayed before loading processing, a URL of the Web page that is displayed after the loading processing, and content information.

The processing in step S1210 is similar to the processing in step S809 of FIG. 8.

An example of the operation when the operations 905 and 907 are performed for the first time, and an example of the operation when the operation 905 is performed for the second time are described with reference to FIGS. 9A and 9B.

In the present embodiment, a URL included in the Web content 904 has the query parameter 1102. A URL included in the Web content 904 selected for the first time is “https://webpagea.co.jp/ad?id=qwert . . . ”. A URL included in the Web content 904 selected for the second time is “https://webpagea.co.jp/ad?id=zxcvb . . . ”.

When the operation 905 is performed for the first time, the page information management unit 412 acquires the page information 1304 in step S1201.

In step S1202, because the page information management unit 412 determines that a combination of page information matching the page information 1304 is not present in the transition limitation list in FIG. 13, the processing proceeds to step S1204.

In step S1205, because a URL of the Web page that is displayed before loading processing stored as the temporary retention page information is not present, the processing proceeds to step S1206.

In step S1206, the display period management unit 413 executes control to display the Web page B corresponding to the URL “https://webpagea.co.jp/ad?id=qwert . . . ”.

Then, in step S1208, the display period management unit 413 acquires the URL 603 of the Web page B.

In step S1209, the display period management unit 413 stores the page information 1304 and the URL 603 of the Web page B that is displayed after loading processing, which have been acquired in steps S1201 and S1208, as the temporary retention page information. Then, the processing proceeds to step S1210.

When the operation 907 is performed, the page information management unit 412 acquires the page information 1305 of FIG. 13 in step S1201.

In step S1202, because the page information management unit 412 determines that a combination of page information matching the page information 1305 is not present in the transition limitation list in FIG. 13, the processing proceeds to step S1204.

In step S1205, the URL 1301 to be loaded, which is described in the page information 1305, and the URL 602 of the Web page that is displayed before loading processing, which have been stored as the temporary retention page information, are not different from each other. Therefore, the processing proceeds to step S1207.

In step S1207, because the display period is less than the threshold, the processing proceeds to step S1211.

In step S1211, the display period management unit 413 determines whether the URL 1301 to be loaded, which is described in the page information 1304 and has been stored as the temporary retention page information, is different from the URL 603 of the Web page that is displayed after loading processing. In this case, the URL 1301 and the URL 603 are different from each other, the processing proceeds to step S1213.

In step S1213, the display period management unit 413 adds the page information 1304 stored as the temporary retention page information to the transition limitation list in FIG. 13. Then, the processing proceeds to step S1206.

In step S1206, the display period management unit 413 executes control to display the Web page A.

Then, in step S1208, the display period management unit 413 acquires the URL 602 of the Web page A.

In step S1209, the display period management unit 413 stores the page information 1305 and the URL 602, which have been acquired in steps S1201 and S1208, of the Web page A that is displayed after loading processing as the temporary retention page information. Then, the processing proceeds to step S1210.

When the operation 905 is performed for the second time, the page information management unit 412 acquires the page information 1304 in step S1201. In this processing, because the query parameter 1102 is excluded, the page information 1304 matching the page information 1304 acquired in step S1201 when the operation 905 has been performed for the first time is acquired.

In step S1202, since the page information management unit 412 determines that a combination of page information matching the page information 1304 is present in the transition limitation list in FIG. 13, the processing proceeds to step S1203, and loading processing is discontinued.

As described above, in step S1202, in a case where a portion excluding the query parameter 1102 in the URL to be loaded based on the first operation is same as a portion excluding the query parameter 1102 in the URL of the Web page expected to be displayed before loading executed last time, and a display period of the Web page displayed last time is less than the threshold, and the portion excluding the query parameter 1102 in the URL to be loaded based on the first operation is different from a portion excluding the query parameter 1102 in the URL of the Web page displayed after loading executed last time, the processing proceeds to step S1203.

In step S1202, in a case where a portion excluding the query parameter 1102 in the URL to be loaded based on the first operation is different from a portion excluding the query parameter 1102 in the URL of the Web page expected to be displayed before loading executed last time, or a display period of the Web page displayed last time is not less than the threshold, or the portion excluding the query parameter 1102 in the URL to be loaded based on the first operation is same as a portion excluding the query parameter 1102 in the URL of the Web page displayed after loading executed last time, the processing proceeds to step S1204.

As described above, through the processing in FIG. 12, it is possible to specify a target based on the combination of page information even in a case where the URL acquired from the Web content before loading processing is different from the URL of the Web page that is displayed after the loading processing. With this configuration, the loading processing is not discontinued even in a case where the user unintentionally selects the Web content, whereby it is possible to solve an issue of displaying a Web page.

### Fourth Embodiment

Differences between a fourth embodiment and the first embodiment are described with respect to an issue occurring from implementation of the processing in FIG. 8 of the first embodiment.

The present embodiment is described with respect to a method for solving an issue in which the loading processing is discontinued even when the user would like to display a Web page once stored in the transition limitation list.

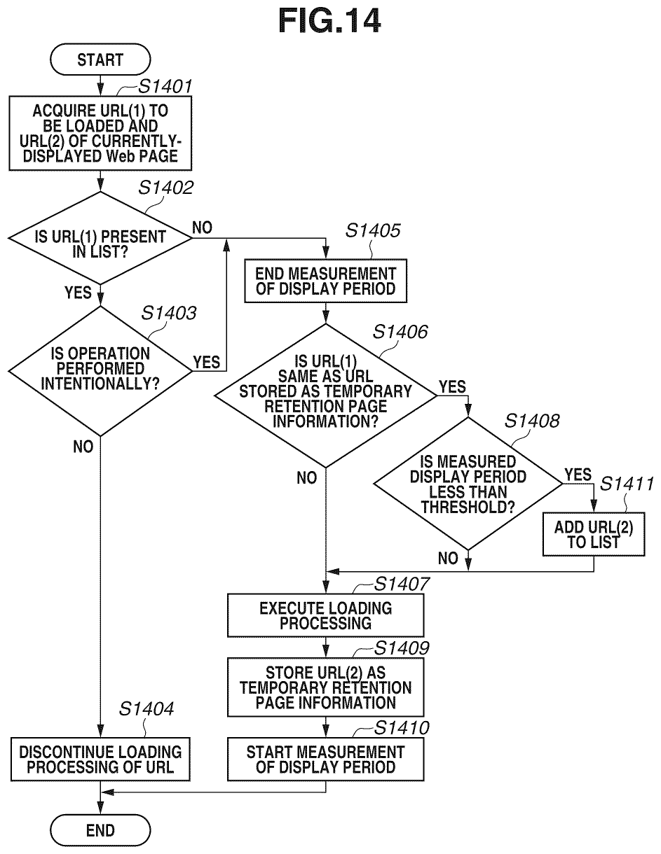

FIG. 14 is a flowchart illustrating the first loading processing according to the present embodiment. The processing illustrated in the flowchart in FIG. 14 is implemented by the CPU 201 loading a program stored in the ROM 202 or the HDD 204 to the RAM 203 and executing the program.

The content of the processing executed in steps S1401, S1402, and S1404 to S1411 corresponds to the content of the processing executed in steps S801, S802, and S803 to S810 in FIG. 8.

In step S1402, in a case where the URL to be loaded is present in the transition limitation list in FIG. 6 (YES in step S1402), the processing proceeds to step S1403. In a case where the URL to be loaded is not present in the transition limitation list in FIG. 6 (NO in step S1402), the processing proceeds to step S1405.

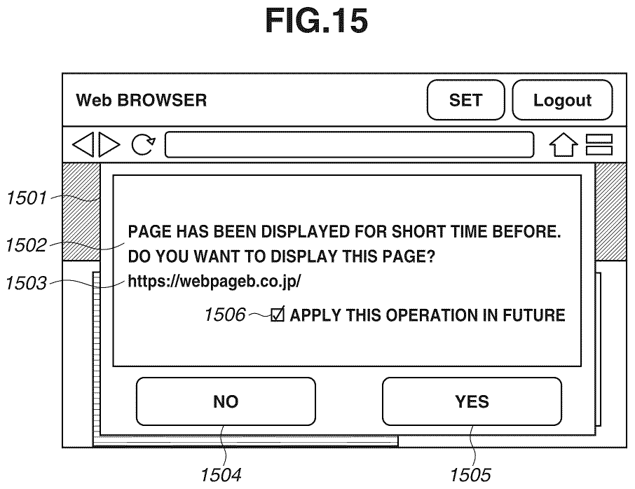

In step S1403, the touch operation management unit 411 executes control to display a redisplay confirmation dialogue in FIG. 15 and prompts the user to confirm whether the operation is performed intentionally. FIG. 15 illustrates an example of the redisplay confirmation dialogue according to the present embodiment. A redisplay confirmation dialogue 1501 is displayed in a Web page rendering area, and includes a text message 1502, a target URL 1503, a NO button 1504, and a YES button 1505.

In a case where the NO button 1504 is selected (NO in step S1403), the processing proceeds to step S1404. In a case where the YES button 1505 is selected (YES in step S1403), the processing proceeds to step S1405. The redisplay confirmation dialogue 1501 may have a check box 1506 which the user ticks in order to apply the operation performed this time to the operation that is performed on the redisplay confirmation dialogue 1501 displayed in future.

In step S1403, the touch operation management unit 411 functions as a display control unit and executes display control to display an inquiry about whether to display a Web page specified by the URL to be loaded based on the first operation as illustrated in FIG. 15.

Based on the display control in FIG. 15, in a case where the user inputs an instruction for not displaying the Web page specified by the URL to be loaded based on the first operation, the processing proceeds to step S1404. Based on the display control in FIG. 15, in a case where the user inputs an instruction for displaying the Web page specified by the URL to be loaded based on the first operation, the processing proceeds to step S1405.

In step S1405, the touch operation management unit 411 deletes the URL based on the coordinates information acquired in step S1401 from the transition limitation list in FIG. 6.

By executing the processing in FIG. 14, loading processing is able to be executed continuously with respect to the Web page for which the user has confirmed that the operation is performed intentionally, via the redisplay confirmation dialogue in FIG. 15. Accordingly, it is possible to solve an issue in which the loading processing is discontinued without user's intention even when the user would like to display the Web page again.

As described above, according to the first to the fourth embodiments, even in a case where the Web content causing erroneous selection is selected again, occurrence of a situation, where the Web page is displayed many times without user's intention, can be prevented without degradation of readability and operability due to discontinuing the loading processing.

The various types of control described above, including the control of the entire apparatus, have been described as the control that is executed by the CPU 201. However, the various types of control may be executed by a single piece of hardware, or may be executed by a plurality of pieces of hardware (e.g., a plurality of processors and circuits) by sharing the processing.

Furthermore, while the present disclosure has been described in detail based on its desirable embodiments, the present disclosure is not limited to these specific embodiments, and various forms within the scope of the gist of this disclosure are also included. Additionally, the above-described embodiments merely illustrate one embodiment of the present disclosure, and it is possible to appropriately combine the embodiments.

Furthermore, while in the above-described embodiments, the present disclosure has been explained using the application example of the present disclosure to the MFP 110, this is not limited to this example and can be applied to any information processing apparatus that displays web pages. That is, the present disclosure can be applied to personal computers, personal digital assistants (PDAs), mobile phone terminals, portable image viewers, printer devices with displays, digital photo frames, music players, game consoles, electronic book readers, and the like.

According to the present disclosure, loading processing of a URL to be loaded based on an operation performed on a Web page is able to be discontinued in a case where the operation satisfies a predetermined condition.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-116935, filed Jul. 22, 2024, which is hereby incorporated by reference herein in its entirety.

What is claimed is:

1. An information processing apparatus comprising:
at least one memory and at least one processor which function as:
a discontinuation unit configured to discontinue, when a first operation including a single operation on a link or a browser-back operation is performed on a Web page, and in a case where a Uniform Resource Locator (URL) to be loaded based on the first operation is same as a URL of a Web page displayed last time, and a display period of the Web page displayed last time is less than a threshold, loading processing of the URL to be loaded based on the first operation; and
a first execution unit configured to execute, when the first operation including the single operation on the link or the browser-back operation is performed on the Web page, and in a case where the URL to be loaded based on the first operation is not same as the URL of the Web page displayed last time, or the display period of the Web page displayed last time is not less than the threshold, the loading processing of the URL to be loaded based on the first operation.

2. The information processing apparatus according to claim 1, wherein the at least one memory and the at least one processor further function as a second execution unit configured to execute, in a case where a second operation including a multi operation on the link or a touch-and-hold operation on the link is performed on the Web page, loading processing of a URL to be loaded based on the second operation.

3. The information processing apparatus according to claim 2, wherein the multi operation on a link is a multi-touch performed on the link.

4. The information processing apparatus according to claim 1,
wherein the at least one memory and the at least one processor further function as a display control unit configured to execute, in a case where the URL to be loaded based on the first operation is same as the URL of the Web page displayed last time, and a display period of the Web page displayed last time is less than the threshold, display control to display an inquiry about whether to display a Web page specified by the URL to be loaded based on the first operation,
wherein, in a case where an instruction for not displaying the Web page specified by the URL to be loaded based on the first operation is issued based on the display control executed by the display control unit, the discontinuation unit discontinues the loading processing of the URL to be loaded based on the first operation, and
wherein, in a case where an instruction for displaying the Web page specified by the URL to be loaded based on the first operation is issued based on the display control executed by the display control unit, the first execution unit executes the loading processing of the URL to be loaded based on the first operation.

5. The information processing apparatus according to claim 1, wherein the first execution unit executes control to display a Web page specified by the URL loaded by the loading processing.

6. The information processing apparatus according to claim 1, further comprising a printer configured to execute printing.

7. The information processing apparatus according to claim 1, further comprising a scanner configured to read an image of a document to generate image data of the image.

8. The information processing apparatus according to claim 1, wherein the single operation on the link is a single-touch performed on the link.

9. A control method of an information processing apparatus comprising:
discontinuing, when a first operation including a single operation on a link or a browser-back operation is performed on a Web page, and in a case where a Uniform Resource Locator (URL) to be loaded based on the first operation is same as a URL of a Web page displayed last time, and a display period of the Web page displayed last time is less than a threshold, loading processing of the URL to be loaded based on the first operation; and
executing, as first executing, when the first operation including the single operation on the link or the browser-back operation is performed on the Web page, and in a case where the URL to be loaded based on the first operation is not same as the URL of the Web page displayed last time, or the display period of the Web page displayed last time is not less than the threshold, the loading processing of the URL to be loaded based on the first operation.

10. An information processing apparatus comprising:
at least one memory and at least one processor which function as:
a discontinuation unit configured to discontinue, when a first operation including a single operation on a link or a browser-back operation is performed in a Web page, and in a case where a portion excluding a query parameter in a URL to be loaded based on the first operation is same as a portion excluding a query parameter in a URL of a Web page expected to be displayed before loading executed last time, and a display period of a Web page displayed last time is less than a threshold, and a portion excluding a query parameter in the URL to be loaded based on the first operation is different from a portion excluding a query parameter in a URL of a Web page displayed after loading executed last time, loading processing of the URL to be loaded based on the first operation; and
a first execution unit configured to execute, when the first operation including the single operation on the link or the browser-back operation is performed on the Web page, and in a case where the portion excluding the query parameter in the URL to be loaded based on the first operation is different from the portion excluding the query parameter in the URL of the Web page expected to be displayed before loading executed last time, or the display period of the Web page displayed last time is not less than the threshold, or the portion excluding the query parameter in the URL to be loaded based on the first operation is same as the portion excluding the query parameter in the URL of the Web page displayed after loading executed last time, loading processing of the URL to be loaded based on the first operation.

11. A control method of an information processing apparatus comprising:
discontinuing, when a first operation including a single operation on a link or a browser-back operation is performed in a Web page, and in a case where a portion excluding a query parameter in a URL to be loaded based on the first operation is same as a portion excluding a query parameter in a URL of a Web page expected to be displayed before loading executed last time, and a display period of a Web page displayed last time is less than a threshold, and a portion excluding a query parameter in the URL to be loaded based on the first operation is different from a portion excluding a query parameter in a URL of a Web page displayed after loading executed last time, loading processing of the URL to be loaded based on the first operation; and
executing, as first executing, when the first operation including the single operation on the link or the browser-back operation is performed on the Web page, and in a case where the portion excluding the query parameter in the URL to be loaded based on the first operation is different from the portion excluding the query parameter in the URL of the Web page expected to be displayed before loading executed last time, or the display period of the Web page displayed last time is not less than the threshold, or the portion excluding the query parameter in the URL to be loaded based on the first operation is same as the portion excluding the query parameter in the URL of the Web page displayed after loading executed last time, loading processing of the URL to be loaded based on the first operation.

12. A non-transitory computer-readable storage medium storing one or more instructions to execute a control method of an information processing apparatus, the method comprising:
discontinuing, when a first operation including a single operation on a link or a browser-back operation is performed on a Web page, and in a case where a Uniform Resource Locator (URL) to be loaded based on the first operation is same as a URL of a Web page displayed last time, and a display period of the Web page displayed last time is less than a threshold, loading processing of the URL to be loaded based on the first operation; and
executing, as first executing, when the first operation including the single operation on the link or the browser-back operation is performed on the Web page, and in a case where the URL to be loaded based on the first operation is not same as the URL of the Web page displayed last time, or the display period of the Web page displayed last time is not less than the threshold, the loading processing of the URL to be loaded based on the first operation.

13. A non-transitory computer-readable storage medium storing one or more instruction to execute a control method of an information processing apparatus, the method comprising:
discontinuing, when a first operation including a single operation on a link or a browser-back operation is performed in a Web page, and in a case where a portion excluding a query parameter in a URL to be loaded based on the first operation is same as a portion excluding a query parameter in a URL of a Web page expected to be displayed before loading executed last time, and a display period of a Web page displayed last time is less than a threshold, and a portion excluding a query parameter in the URL to be loaded based on the first operation is different from a portion excluding a query parameter in a URL of a Web page displayed after loading executed last time, loading processing of the URL to be loaded based on the first operation; and
executing, as first executing, when the first operation including the single operation on the link or the browser-back operation is performed on the Web page, and in a case where the portion excluding the query parameter in the URL to be loaded based on the first operation is different from the portion excluding the query parameter in the URL of the Web page expected to be displayed before loading executed last time, or the display period of the Web page displayed last time is not less than the threshold, or the portion excluding the query parameter in the URL to be loaded based on the first operation is same as the portion excluding the query parameter in the URL of the Web page displayed after loading executed last time, loading processing of the URL to be loaded based on the first operation.
